(19) United States
(12) Patent Application Publication
(10) Pub. No.: US 2004/0262205 A1
(43) Pub. Date: Dec. 30, 2004

(54) Filtration system having hydrophilic capillary membranes

(76) Inventor: George Binau, Horsholm (DK)

Correspondence Address: MERCHANT & GOULD PC, P.O. BOX 2903, MINNEAPOLIS, MN, 55402-0903, US

(21) Appl. No.: 10/493,555

(22) PCT Filed: Oct. 23, 2002
(86) PCT No.: PCT/DK02/00704

(30) Foreign Application Priority Data
Oct. 24, 2001 (DK) BA 2001 00286

(51) Int. Cl. B01D 65/02

(52) U.S. Cl. 210/108; 210/321.69; 210/321.89; 210/323.2; 210/332

(57) ABSTRACT

The present invention relates to a filtration system for filtration of domestic water, wherein the filtration system comprises at least one capillary membrane module, said capillary membrane module comprising a number of hydrophilic capillary membranes. According to a preferred embodiment the capillary membrane module has a feeding side for inlet of untreated domestic water, a permeated side for outlet of treated water, and a concentrate side for outlet of rinsing water, wherein a rinsing or flushing valve is arranged on the concentrate side for opening and closing of the rinsing water outlet, said rinsing or flushing valve having an inlet side and an outlet side. The use of hydrophilic capillary membranes leads to the result that when the rinsing or flushing valve is opened during operation, then a backwards flush of the membrane walls from the permeate side to the concentrate side is obtained with the result that the system can be operated for long periods of time without any renewal of membranes or without performing a manual rinsing of the system.

### FIELD OF THE INVENTION

The present invention relates to a filtration system for filtration of domestic water, the filtration process being carried out by use of one or more capillary membrane modules.

### PRIOR ART

Filtration systems having membrane modules with capillary membranes are known in the art. Here, the single capillary membrane is tubular or pipe-shaped with a permeable wall, and a filtration may be carried out by feeding water into the inner part of the capillary tube using a first end of the tube, and, having the other end of the capillary tube closed, the water passes through the wall of the capillary tube, whereby the filtered water may be carried away from the outside of the capillary tube.

A filtration process may also be carried out by passing the water in the opposite direction, i.e. from the outside of the capillary tube, through the wall and out via one or both ends of the inner part of the capillary tube.

When filtering domestic water by use of capillary membranes a problem arises in relation to rinsing or flushing of the membranes. Usually, hydrophobic membranes having a water-repellent effect are used. The result is that it may be difficult to perform an effective flush of these membranes, and especially It may be difficult to perform a “backwards” flush or “backflush” through the walls of the membranes, by which is meant that the flush is performed in the opposite direction of the flow during the filtration process. This may lead to the result that bacteria may be accumulated in the system, whereby the system may be useless for filtration of domestic water, or that the capillary membranes have to be renewed frequently.

### SUMMARY OF THE INVENTION

According to the present invention there is provided a filtration system for filtration of domestic water, said filtration system comprising at least one capillary membrane module, wherein said capillary membrane module comprises a number of hydrophilic capillary membranes.

According to an embodiment of the invention, the capillary membrane module has a feeding side for inlet of untreated domestic water, a permeate side for outlet of treated water, and a concentrate side for outlet of rinsing water, wherein a rinsing or flushing valve is arranged on the concentrate side for opening and closing of the rinsing water outlet, said rinsing or flushing valve having an inlet side and an outlet side.

It is also within an embodiment of the invention that the filtration system is dimensioned so that untreated domestic water can be conducted from the feeding side to an inner side of the capillary membranes and can be filtered by permeating from said inner side through the walls of a capillary membrane to the outer side of the capillary membrane, the outer side of the capillary membranes being connected to the permeate side so that the filtered water can be conducted away from the outer side of the capillary membranes via the permeate side.

It is preferred that the filtration system of the present invention is dimensioned so that the concentrate side for outlet of rinsing water is connected to the inner side of the capillary membranes, so that when the rinsing or flushing valve is open then water can be conducted from the inner part of the capillary membranes to the concentrate side and out via the rinsing water outlet.

It is also preferred that filtration the system of the invention is dimensioned to have a buffer volume of treated water on the permeate side during normal operation when untreated water is supplied to the feeding side and the rinsing or flushing valve is closed. Here, the system may be further dimensioned so that rinsing water is conducted away from the outlet side of the rinsing or flushing valve to thereby lower the pressure on the outlet side of said valve.

The present inventions also covers an embodiment in which the filtration system is dimensioned so that when the system is in operation and the rinsing or flushing valve is closed, then on the feeding side, on the permeate side and on the inlet side of the rinsing or flushing valve there will be a water pressure being higher than the pressure on the outlet side of the rinsing or flushing valve, so that when the rinsing or flushing valve is opened, then a pressure equalization takes place by having untreated water being conducted directly from the feeding side through the inner part of the capillary membranes to the concentrate side and through the rinsing or flushing valve to the rinsing water outlet and by having treated water being conducted from the permeate side through the walls in the capillary membranes to the concentrate side and through the rinsing or flushing valve to the rinsing water outlet.

In a preferred embodiment of the present invention the filtration system is dimensioned to have a buffer volume of treated water on the permeate side during normal operation when untreated water is supplied to the feeding side and the rinsing or flushing valve is closed, and the system is further dimensioned so that rinsing water is conducted away from the outlet side of the rinsing or flushing valve to thereby lower the pressure on the outlet side of said valve, whereby on the feeding side, on the permeate side and on the inlet side of the rinsing or flushing valve there will be a water pressure being higher than the pressure on the outlet side of the rinsing or flushing valve during normal operation, so that when the rinsing or flushing valve is opened, then a pressure equalization takes place by having untreated water being conducted directly from the feeding side through the inner part of the capillary membranes to the concentrate side and through the rinsing or flushing valve to the rinsing water outlet and by having treated water being conducted from the permeate side through the walls in the capillary membranes to the concentrate side and through the rinsing or flushing valve to the rinsing water outlet.

Thus, according to an embodiment of the present invention there is provided a filtration system for filtration of domestic water, said filtration system comprising at least one capillary membrane module having a number of hydrophilic capillary membranes, wherein:

the capillary membrane module has a feeding side for inlet of untreated domestic water, a permeate side for outlet of treated water, and a concentrate side for outlet of rinsing water, with a rinsing or flushing valve being arranged on the concentrate side for opening and closing of the rinsing water outlet, said rinsing or flushing valve having an inlet side and an outlet side;

the untreated domestic water can be conducted from the feeding side to an inner side of the capillary membranes and can be filtered by permeating from said inner side through the walls of a capillary membrane to the outer side of the capillary membrane, the outer side of the capillary membranes being connected to the permeate side so that the filtered water can be conducted away from the outer side of the capillary membranes via the permeate side;

the concentrate side for outlet of rinsing water is connected to the inner side of the capillary membranes, so that when the rinsing or flushing valve is open then water can be conducted from the inner part of the capillary membranes to the concentrate side and out via the rinsing water outlet; and

the system is dimensioned so that when the system is in operation and the rinsing or flushing valve is closed, then on the feeding side, on the permeate side and on the inlet side of the rinsing or flushing valve there will be a water pressure being higher than the pressure on the outlet side of the rinsing or flushing valve, so that when the rinsing or flushing valve is opened, then a pressure equalization takes place by having untreated water being conducted directly from the feeding side through the inner part of the capillary membranes to the concentrate side and through the rinsing or flushing valve to the rinsing water outlet and by having treated water being conducted from the permeate side through the walls in the capillary membranes to the concentrate side and through the rinsing or flushing valve to the rinsing water outlet.

According to an embodiment of the present invention there is also provided a filtration system for filtration of domestic water, said filtration system comprising at least one capillary membrane module having a number of hydrophilic capillary membranes, wherein:

the capillary membrane module has a feeding side for inlet of untreated domestic water, a permeate side for outlet of treated water, and a concentrate side for outlet of rinsing water,

a rinsing or flushing valve is arranged on the concentrate side for opening and closing of the rinsing water outlet, said rinsing or flushing valve having an inlet side and an outlet side;

the untreated domestic water can be conducted from the feeding side to an inner side of the capillary membranes and can be filtered by permeating from said inner side through the walls of a capillary membrane to the outer side of the capillary membrane, the outer side of the capillary membranes being connected to the permeate side so that the filtered water can be conducted away from the outer side of the capillary membranes via the permeate side;

the concentrate side for outlet of rinsing water is connected to the inner side of the capillary membranes, so that when the rinsing or flushing valve is open then water can be conducted from the inner part of the capillary membranes to the concentrate side and out via the rinsing water outlet; and

the filtration system is dimensioned to have a buffer volume of treated water on the permeate side during normal operation when untreated water is supplied to the feeding side and the rinsing or flushing valve is closed, and the filtration system is further dimensioned so that rinsing water is conducted away from the outlet side of the rinsing or flushing valve to thereby lower the pressure on the outlet side of said valve, whereby on the feeding side, on the permeate side and on the inlet side of the rinsing or flushing valve there will be a water pressure being higher than the pressure on the outlet side of the rinsing or flushing valve during normal operation, so that when the rinsing or flushing valve is opened, then a pressure equalization takes place by having untreated water being conducted directly from the feeding side through the inner part of the capillary membranes to the concentrate side and through the rinsing or flushing valve to the rinsing water outlet and by having treated water being conducted from the permeate side through the walls in the capillary membranes to the concentrate side and through the rinsing or flushing valve to the rinsing water outlet.

For the filtration systems of the present invention it is preferred that the rinsing or flushing valve can be opened and closed at predetermined time intervals. It is also preferred that the rinsing or flushing valve can be opened relatively quickly and can be closed relatively slowly, so that the time used for opening of the rinsing or flushing valve is shorter than the time used for closing the rinsing or flushing valve.

According to the present invention there is also provided a method of flushing a filtration system for filtration of domestic water, said filtration system comprising at least one capillary membrane module having a number of hydrophilic capillary membranes, wherein:

the capillary membrane module has a feeding side for inlet of untreated domestic water, a permeate side for outlet of treated water, and a concentrate side for outlet of rinsing water;

a rinsing or flushing valve is arranged on the concentrate side for opening and closing of the rinsing water outlet, said rinsing or flushing valve having an inlet side and an outlet side;

the untreated domestic water can be conducted from the feeding side to an inner side of the capillary membranes and can be filtered by permeating from said inner side through the walls of a capillary membrane to the outer side of the capillary membrane, the outer side of the capillary membranes being connected to the permeate side so that the filtered water can be conducted away from the outer side of the capillary membranes via the permeate side;

the concentrate side for outlet of rinsing water is connected to the inner side of the capillary membranes, so that when the rinsing or flushing valve is open then water can be conducted from the inner part of the capillary membranes to the concentrate side and out via the rinsing water outlet; and

the filtration system is dimensioned to have a buffer volume of treated water on the permeate side during normal operation when untreated water is supplied to the feeding side and the rinsing or flushing valve is closed, and the filtration system is further dimensioned so that rinsing water is conducted away from the outlet side of the rinsing or flushing valve to thereby lower the pressure on the outlet side of said valve;

said method comprising the steps of:

maintaining a supply of untreated domestic water to the feeding side of the membrane module while maintaining the rinsing or flushing valve closed, to thereby establish a buffer volume of treated water on the permeate side of the membrane module, whereby on the feeding side, on the permeate side and on the inlet side of the rinsing or flushing valve there will be a water pressure being higher than the pressure on the outlet side of the rinsing or flushing valve;

opening the rinsing or flushing valve while maintaining the supply of untreated domestic Water to the feeding side, whereby a pressure equalization takes place by having untreated water being conducted directly from the feeding side through the inner part of the capillary membranes to the concentrate side and through the rinsing or flushing valve to the rinsing water outlet and by having treated water being conducted from the permeate side through the walls in the capillary membranes to the concentrate side and through the rinsing or flushing valve to the rinsing water outlet; and

closing the rinsing or flushing valve.

For the method of the present invention It is preferred that the supply of untreated domestic water to the feeding side is maintained at least until the closing of the rinsing or flushing valve if finished. It is also preferred that the time used for opening of the rinsing or flushing valve is shorter than the time used for closing the rinsing or flushing valve.

Preferably, the rinsing or flushing valve is kept open for time periods in the range of 1-6 seconds. The opening and closing of the rinsing or flushing valve may be controlled by a PLC (programmable logic controller). It is also preferred that the rinsing or flushing valve is a magnetic valve.

It is preferred that a membrane module of the filtration system of the present invention comprises several capillary membranes in the form of hydrophilic capillary straws, each capillary straw comprising several capillary tubes. Here, a capillary straw may comprise at least 3 capillary tubes, such as at least 5 capillary tubes, or such as at least 7 capillary tubes. It is also preferred that a capillary straw comprises no more than 15 capillary tubes, or no more than 10 capillary tubes.

The hydrophilic capillary membranes may be made of different suitable materials, but It is preferred that they are made of polyether sulphone.

It should be understood that according to the present invention the filtration system may comprise several membrane modules such as at least 2 or 3 membrane modules. Here, It is preferred that a rinsing or flushing valve is arranged on the concentrate side of each membrane module. The outlet of each rinsing or flushing valve may be connected to the rinsing water outlet.

According to an embodiment of the invention, a capillary membrane may be a capillary straw having an outer diameter about 4 mm, and each capillary straw may comprise 7 capillary tubes with each capillary tube having an inner diameter about 0.8 mm.

Different dimensions may be used for the capillary membrane module, and according to an embodiment of the invention, a capillary membrane module has a diameter of 2 inches (Danish inches) and comprises about 60 capillary straws. It is also within an embodiment of the invention that a capillary membrane module has a diameter of 4 inches (Danish inches) and comprises about 300 capillary straws. The invention furthermore covers an embodiment wherein a capillary membrane module has a diameter of 8 inches (Danish inches) and comprises about 1060 capillary straws.

It is preferred that the capillary membranes are sealed in both ends of a capillary membrane module so that from the ends of the modules, water can be conducted into the capillary membrane module via the inner sides of the capillary membranes only.

According to the present invention the filtration system may be dimensioned for a wide range of operating pressure on the feeding side, but it is preferred that the system is dimensioned for an operating pressure on the feeding side in the range of 0.1-8 bar. Here, the system may preferably be dimensioned for an operating pressure on the feeding side about 3 bar.

By using hydrophilic capillary membranes, the water-repellent effect that is shown by hydrophobic membranes is avoided. Hereby, the possibility of rinsing or flushing of the membrane is made much easier, and it is possible to produce a filtration system for which a backwards flush, which results in a better rinsing or cleaning of the membrane walls, can be performed, whereby an accumulation of bacteria in the membrane walls is avoided. The present invention and particular advantageous embodiments are explained in details in the following with reference to the figures on the drawing.

### BRIEF DESCRIPTION OF THE DRAWINGS

FIG. 1 shows a preferred embodiment of a capillary membrane module according to the present invention.

FIG. 2 is a block diagram of a preferred filtration system according to the present invention.

FIG. 3 illustrates conditions of flow and pressure during flushing of a filtration system according to the present invention.

### DESCRIPTION OF PREFERRED EMBODIMENTS

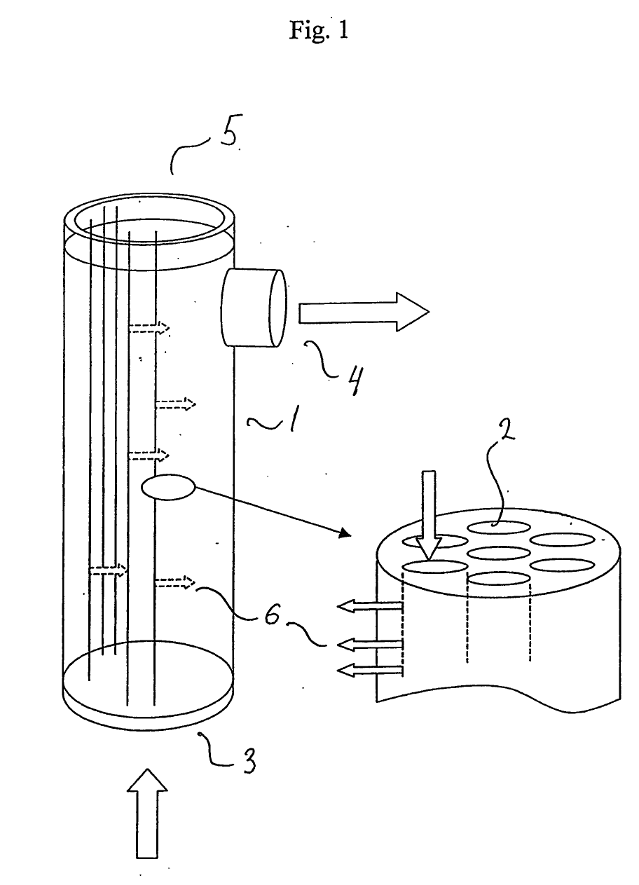

FIG. 1 shows a preferred embodiment of a capillary membrane module, which can be used in a filtration system according to the present invention. The module 1 has a number of capillary membranes 2, also named capillary straw, which are cast in both ends of the module 1, so that water can be passed to or from the module ends via the ends of the capillary membranes 2 only. The module 1 has a feeding side 3 for supply of untreated water, a permeate side 4 for outlet of treated water, and a concentrate side 5 for outlet of rinsing water. The concentrate side 5 may be closed by use of a rinsing or flushing valve, not shown in FIG. 1. When the concentrate side 5 is closed, then water being supplied from the feeding side 3 will permeate the membrane walls, as Illustrated by the arrows 6, to be discharged from the permeate side 4.

The capillary membrane 2 used here is a hydrophilic membrane. According to a preferred embodiment the capillary membrane is of a type being manufactured by S. Search B.V. and being produced from polyether sulphone (PES), which is a mixture of a hydrophilic polymeric material and a hydrophobic polymeric material, which following a special treatment results in a material of a permanent hydrophilic character. The capillary membrane consists of a special construction in which 7 capillary tubes are arranged in a main capillary straw 2. This type of capillary membranes is described in International Patent Application No. WO 102085 having S. Search B.V. as applicant, and which is hereby included by reference. By having several capillary tubes inside each capillary membrane or capillary straw 2, an extraordinary large tensile strength is obtained compared to the traditional “single capillaries” resulting in a much higher security with regard to breakage. The capillary membrane used here is tested to a differential pressure of more than 20 bar. Each of the 7 capillary tubes has an inner diameter of 0.8 mm and the outer diameter of the capillary straw is 4 mm. The walls of the individual capillary tubes are permeable via a number of membrane pores with the size of the pores being about 0.03 μm.

According to a preferred embodiment the filtration system is based on the use of membrane modules having an outer diameter of 2, 4 or 8 inches (Danish inches), and a length of 400, 500, 1000 or 1500 mm. For modules of 2 inches (Danish inches) it is preferred that about 60 capillary straws are used per module, for modules of 4 inches (Danish inches) it is preferred that about 300 capillary straws are used per module, and for modules of 8 inches (Danish inches) it is preferred that about 1060 capillary straws are used per module.

The present invention also includes a filtration system, in which the hydrophilic capillary membranes of the membrane module are separate hydrophilic capillary tubes, so that in this case the capillary membrane is not a capillary straw with several capillary tubes.

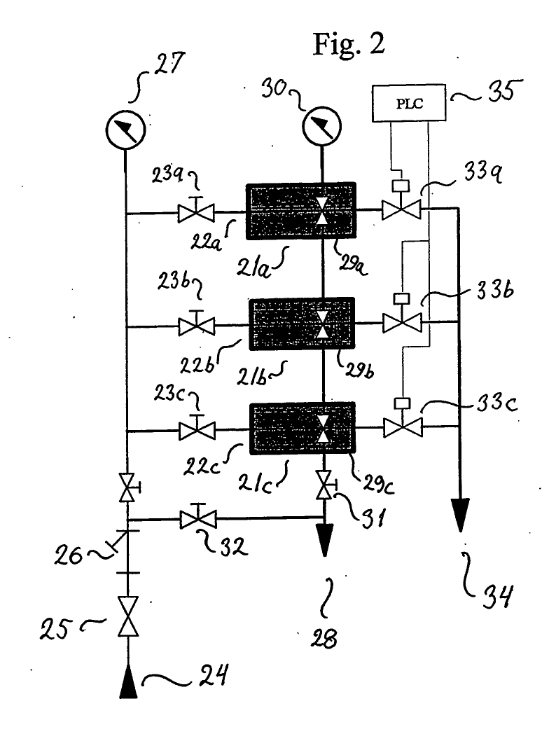

FIG. 2 shows a block diagram of a preferred filtration system according to the present invention. For the illustrated system there are used three 4 inch type membrane modules 21a, 21b, 21c being of the type described in connection with FIG. 1. Each membrane module has a feeding side 22a, 22b, 22b being connected to the inlet for untreated domestic water 24 by manually operated closing or shut-off valves 23a, 23b, 23c, where the domestic water first passes a non-return or check valve 25 and a pre-valve or strainer 26. On the inlet side there is furthermore placed a manometer or pressure gauge 27. The system has an outlet for clean water 28 being connected to the outputs on the permeate side of the individual modules by closing or shut-off valves 29a, 29b, 29c. Furthermore, there is placed a manometer or a pressure gauge 30, an extra outlet valve 31 and a valve 32 between the inlet and the outlet. On the concentrate side each module is connected to an outlet for rinsing water 34 by magnetic valves 33a, 33b, 33c. The magnetic valves 33a, 33b, 33c are controlled by use of a PLC (programmable logic controller) circuit 35.

The filtration system shown in FIG. 2 can be directly inserted in domestic water systems using the existing water pressure as a source of energy for operating the membrane function. The system will mainly/typically operate in a pressure range of 0.1-8.0 bar. The unfiltered domestic water is now passed via the strainer 26 and the non-return valve 25 directly to the inner side of the capillary tubes of the membrane modules, which modules constitute sealed pressure tubes in which the feeding side 3 and the concentrate side 5 are sealed by use of a “potting”. This sealing ensures a complete separation of untreated water and clean water. In the opposite end of the feeding side 3 is mounted a magnetic valve 33, which is closed during normal operation with no flush or rinsing of the membranes. The existing water pressure squeezes the water through the capillary membrane wall to be collected on the clean water side or the permeate side 4, from where the water is passed for consumption of clean water. When the filtration system of FIG. 2 is inserted in a domestic water system, then during normal operation there will be a so-called “buffer” volume of clean water in the tube system (not shown in FIG. 2) connected to the clean water outlet 28 and in the membrane modules 21a, 21b, 21c.

At predetermined time intervals the magnetic valves 33a, 33b, 33c are opened, whereupon a flush function is performed. In a preferred embodiment a flush is performed for every 6th hour. At the start of this flush function, clean water will be squeezed backwards, “back-flush”, from the permeate side 4 to the inner side of the capillary tubes and the concentrate side 5, and untreated water will be squeezed forwards, “forward flush”, in the capillary tubes from the feeding side 3 to the concentrate side 5. After a while, the difference in pressure between the permeate side 4 and the concentrate side 5 is no longer large enough to maintain a back-flush, and there only remains a forward flush function. This forward flush function, which is a function lasting about 2-6 seconds, conducts the collected concentrate to the outlet 34. Hereafter, the magnetic valves 33a, 33b, 33c are slowly closed by use of a “slowly closing valve in order to avoid an extraordinary water hammer in the water supply. The system is then re-established with rinsing and conducting away of undesirable particles and bacteria.

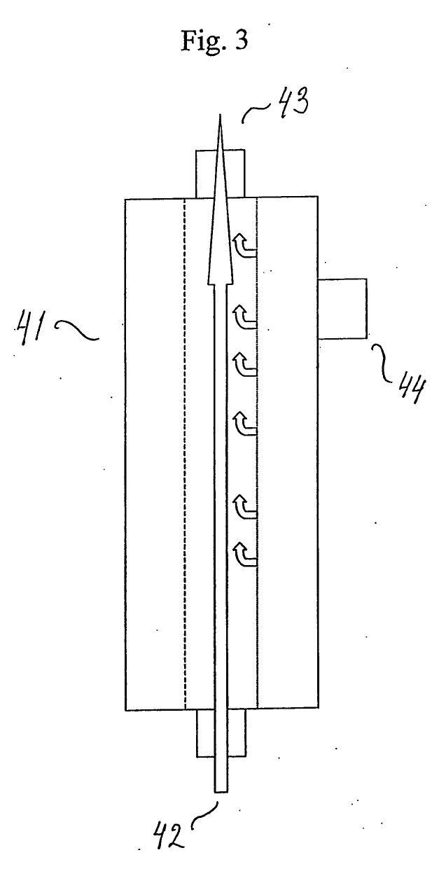

FIG. 3 Illustrates the flow conditions and the pressure conditions during the above-described flush function. In FIG. 3 is schematically shown a membrane module 41 of the type described in connection with FIG. 1. In a typical situation of operation, for example with a pressure of 3 bar at the feeding side 42, the pressure will be similar at the concentrate side 43 and at the permeate side 44, where there is outlet for clean water, provided that there is no or only a relatively small consumption of clean water on the permeate or clean water side 44 of the system. Thus, there will be about 3 bar at the feeding side 42, at the clean water outlet 44, and at the concentrate side 43, as the magnetic valve 33 (not shown on FIG. 3) is closed. If the magnetic valve 33 on the concentrate side 43 is opened relatively fast, then within a short time interval there will be created an overpressure on the feeding side 42 and on the permeate side 44 due to the already established pressure before the magnetic valve 33 was opened. Volume of water at the clean water side or permeate side 44 will try to permeate the capillary membrane from the clean water side 44 to the concentrate side 43 due to an overpressure from the existing buffer capacity, i.e. the volume of water from the membrane module itself and the volume of water from the tube system. The function results in a sort of pressure chock with a backward flush of the membrane wall for a short time interval depending on the length of the membrane module. When the pressure conditions across the membrane module 41 are re-established there will no longer be a backward flush and hereafter there will only be a forward flush directly from the feeding side 42.

The backwards penetration of water from the permeate side 44 of the membrane towards the concentrate side 43 is increased due to the hydrophilic characteristics of the membrane. If a hydrophobic membrane is used, then it will not be possible to obtain the same effective backwards flush function, and it will thus not be possible to obtain the desired rinsing effect, which is important for the function and operation of the system during a long time period as for example 1-2 years without any special manual rinsing or cleaning, as for this period of time there will only be performed an automatic flush. For the system of FIG. 2, then according to a preferred embodiment, an automatic flush will be performed for every 6th hour.

While the invention has been particularly shown and described with reference to particular embodiments, it will be understood by those skilled in the art that various changes in form and details may be made therein without departing from the spirit and scope of the invention, and it is intended that such changes come within the scope of the following claims.

1. A filtration system for filtration of domestic water, said filtration system comprising at least one capillary membrane module, wherein said capillary membrane module comprises a number of hydrophilic capillary membranes.

2. A filtration system according to claim 1, wherein a membrane module comprises several capillary membranes in the form of hydrophilic capillary straws, each capillary straw comprising several capillary tubes.

3. A filtration system according to claim 2, wherein a capillary straw comprises at least 3 capillary tubes.

4. A filtration system according to claim 3, wherein a capillary straw comprises at least 5 capillary tubes.

5. A filtration system according to claim 4, wherein a capillary straw comprises at least 7 capillary tubes.

6. A filtration system according to any one of the claims 2-5, wherein a capillary straw comprises no more than 15 capillary tubes.

7. A filtration system according to claim 6, wherein a capillary straw comprises no more than 10 capillary tubes.

8. A filtration system according to any one of the preceding claims, wherein the hydrophilic capillary membranes are made of polyether sulphone.

9. A filtration system according to any one of the preceding claims, wherein the capillary membrane module has a feeding side for inlet of untreated domestic water, a permeate side for outlet of treated water, and a concentrate side for outlet of rinsing water, wherein a rinsing or flushing valve is arranged on the concentrate side for opening and closing of the rinsing water outlet, said rinsing or flushing valve having an inlet side and an outlet side.

10. A filtration system according to any one of the preceding claims, wherein untreated domestic water can be conducted from the feeding side to an inner side of the capillary membranes and can be filtered by permeating from said inner side through the walls of a capillary membrane to the outer side of the capillary membrane, the outer side of the capillary membranes being connected to the permeate side so that the filtered water can be conducted away from the outer side of the capillary membranes via the permeate side.

11. A filtration system according to claim 9 or 10, wherein the concentrate side for outlet of rinsing water is connected to the inner side of the capillary membranes, so that when the rinsing or flushing valve is open then water can be conducted from the inner part of the capillary membranes to the concentrate side and out via the rinsing water outlet.

12. A filtration system according to claim 9, 10 or 11, wherein the system is dimensioned to have a buffer volume of treated water on the permeate side during normal operation when untreated water is supplied to the feeding side and the rinsing or flushing valve is closed.

13. A filtration system according to claim 12, wherein the system is further dimensioned so that rinsing water is conducted away from the outlet side of the rinsing or flushing valve to thereby lower the pressure on the outlet side of said valve.

14. A filtration system according to any one of the claims 9-13, wherein when the system is in operation and the rinsing or flushing valve is closed, then on the feeding side, on the permeate side and on the inlet side of the rinsing or flushing valve there will be a water pressure being higher than the pressure on the outlet side of the rinsing or flushing valve, so that when the rinsing or flushing valve is opened, then a pressure equalization takes place by having untreated water being conducted directly from the feeding side through the inner part of the capillary membranes to the concentrate side and through the rinsing or flushing valve to the rinsing water outlet and by having treated water being conducted from the permeate side through the walls in the capillary membranes to the concentrate side and through the rinsing or flushing valve to the rinsing water outlet.

15. A filtration system according to claim 9, 10 or 11, wherein the system is dimensioned to have a buffer volume of treated water on the permeate side during normal operation when untreated water is supplied to the feeding side and the rinsing or flushing valve is closed, and the system is further dimensioned so that rinsing water is conducted away from the outlet side of the rinsing or flushing valve to thereby lower the pressure on the outlet side of said valve, whereby on the feeding side, on the permeate side and on the inlet side of the rinsing or flushing valve there will be a water pressure being higher than the pressure on the outlet side of the rinsing or flushing valve during normal operation, so that when the rinsing or flushing valve is opened, then a pressure equalization takes place by having untreated water being conducted directly from the feeding side through the inner part of the capillary membranes to the concentrate side and through the rinsing or flushing valve to the rinsing water outlet and by having treated water being conducted from the permeate side through the walls in the capillary membranes to the concentrate side and through the rinsing or flushing valve to the rinsing water outlet.

16. A filtration system according to any one of the claims 9-15, wherein the rinsing or flushing valve can be opened and closed at predetermined time intervals.

17. A filtration system according to any one of the claims 9-16, wherein the rinsing or flushing valve can be opened relatively quickly and can be closed relatively slowly, so that the time used for opening of the rinsing or flushing valve is shorter than the time used for closing the rinsing or flushing valve.

18. A filtration system according to claim 16 or 17, wherein the rinsing or flushing valve is kept open for time periods in the range of 1-6 seconds.

19. A filtration system according to any one of the claims 16-18, wherein opening and closing of the rinsing or flushing valve is controlled by a PLC (programmable logic controller).

20. A filtration system according to any one of the claims 9-19, wherein the rinsing or flushing valve is a magnetic valve.

21. A filtration system according to any one of the preceding claims, wherein the system comprises at least 2 or 3 membrane modules.

22. A filtration system according to any one of the claims 9-21, wherein a rinsing or flushing valve is arranged on the concentrate side of each membrane module.

23. A filtration system according to claim 20, wherein the outlet of each rinsing or flushing valve is connected to the rinsing water outlet.

24. A filtration system according to any one of the claims 2-23, wherein a capillary membrane is a capillary straw having an outer diameter about 4 mm, and each capillary straw comprises 7 capillary tubes with each capillary tube having an inner diameter about 0.8 mm.

25. A filtration system according to any one of the claims 2-24, wherein a capillary membrane module has a diameter of 2 inches (Danish inches) and comprises about 60 capillary straws.

26. A filtration system according to any one of the claims 2-24, wherein a capillary membrane module has a diameter of 4 inches (Danish inches) and comprises about 300 capillary straws.

27. A filtration system according to any one of the claims 2-24, wherein a capillary membrane module has a diameter of 8 inches (Danish inches) and comprises about 1060 capillary straws.

28. A filtration system according to any one of the preceding claims, wherein the capillary membranes are sealed in both ends of a capillary membrane module so that from the ends of the modules, water can be conducted into the capillary membrane module via the inner sides of the capillary membranes only.

29. A filtration system according to any one of the preceding claims, wherein the system is dimensioned for an operating pressure on the feeding side in the range of 0.1-8 bar.

30. A filtration system according to claim 29, wherein the system is dimensioned for an operating pressure on the feeding side about 3 bar.

31. A method of flushing a filtration system for filtration of domestic water, said filtration system comprising at least one capillary membrane module having a number of hydrophilic capillary membranes, wherein:
the capillary membrane module has a feeding side for inlet of untreated domestic water, a permeate side for outlet of treated water, and a concentrate side for outlet of rinsing water;
a rinsing or flushing valve is arranged on the concentrate side for opening and closing of the rinsing water outlet, said rinsing or flushing valve having an inlet side and an outlet side;
the untreated domestic water can be conducted from the feeding side to an inner side of the capillary membranes and can be filtered by permeating from said inner side through the walls of a capillary membrane to the outer side of the capillary membrane, the outer side of the capillary membranes being connected to the permeate side so that the filtered water can be conducted away from the outer side of the capillary membranes via the permeate side;
the concentrate side for outlet of rinsing water is connected to the inner side of the capillary membranes, so that when the rinsing or flushing valve is open then water can be conducted from the inner part of the capillary membranes to the concentrate side and out via the rinsing water outlet; and
the filtration system is dimensioned to have a buffer volume of treated water on the permeate side during normal operation when untreated water is supplied to the feeding side and the rinsing or flushing valve is closed, and the filtration system is further dimensioned so that rinsing water is conducted away from the outlet side of the rinsing or flushing valve to thereby lower the pressure on the outlet side of said valve;
said method comprising the steps of:
maintaining a supply of untreated domestic water to the feeding side of the membrane module while maintaining the rinsing or flushing valve closed, to thereby establish a buffer volume of treated water on the permeate side of the membrane module, whereby on the feeding side, on the permeate side and on the inlet side of the rinsing or flushing valve there will be a water pressure being higher than the pressure on the outlet side of the rinsing or flushing valve;
opening the rinsing or flushing valve while maintaining the supply of untreated domestic water to the feeding side, whereby a pressure equalization takes place by having untreated water being conducted directly from the feeding side through the inner part of the capillary membranes to the concentrate side and through the rinsing or flushing valve to the rinsing water outlet and by having treated water being conducted from the permeate side through the walls in the capillary membranes to the concentrate side and through the rinsing or flushing valve to the rinsing water outlet; and
closing the rinsing or flushing valve.

32. A method according to claim 31, wherein the supply of untreated domestic water to the feeding side is maintained at least until the closing of the rinsing or flushing valve if finished.

33. A method according to claim 31 or 32, wherein the time used for opening of the rinsing or flushing valve is shorter than the time used for closing the rinsing or flushing valve.

34. A method according to any one of the claims 31-33, wherein the rinsing or flushing valve is kept open for a time period in the range of 1-6 seconds.

35. A method according to any one of the claims 31-34, wherein the rinsing or flushing valve is opened and closed at predetermined time intervals.

36. A method according to any one of the claims 31-35, wherein opening and closing of the rinsing or flushing valve is controlled by a PLC (programmable logic controller)

37. A method according to any one of the claims 31-36, wherein the rinsing or flushing valve is a magnetic valve.

38. A method according to any one of the preceding claims, wherein the system comprises at least 2 or 3 membrane modules.

39. A method according to claim 38, wherein a rinsing or flushing valve is arranged on the concentrate side of each membrane module.

40. A method according to claim 39, wherein the outlet of each rinsing or flushing valve is connected to the rinsing water outlet.

41. A method according to any one of the claims 31-40, wherein a membrane module comprises several capillary membranes in the form of hydrophilic capillary straws, each capillary straw comprising several capillary tubes.

42. A method according to claim 41, wherein a capillary straw comprises at least 3 capillary tubes.

43. A method according to claim 42, wherein a capillary straw comprises at least 5 capillary tubes.

44. A method according to claim 43, wherein a capillary straw comprises at least 7 capillary tubes.

45. A method according to any one of the claims 41-44, wherein a capillary straw comprises no more than 15 capillary tubes.

46. A method according to claim 45, wherein a capillary straw comprises no more than 10 capillary tubes.

47. A method according to any one of the claims 31-46, wherein the hydrophilic capillary membranes are made of polyether sulphone.

48. A method according to any one of the claims 41-47, wherein a capillary membrane is a capillary straw having an outer diameter about 4 mm, and in that each capillary straw comprises 7 capillary tubes with each capillary tube having an inner diameter about 0.8 mm.

49. A method according to any one of the claims 41-48, wherein a capillary membrane module has a diameter of 2 inches (Danish inches) and comprises about 60 capillary straws.

50. A method according to any one of the claims 41-48, wherein a capillary membrane module has a diameter of 4 inches (Danish inches) and comprises about 300 capillary straws.

51. A method according to any one of the claims 41-48, wherein a capillary membrane module has a diameter of 8 inches (Danish inches) and comprises about 1060 capillary straws.

52. A method according to any one of the claims 31-51, wherein the capillary membranes are sealed in both ends of a capillary membrane module so that from the ends of the modules, water can be conducted into the capillary membrane module via the inner sides of the capillary membranes only.

53. A method according to any one of the claims 31-52, wherein the filtration system is dimensioned for an operating pressure on the feeding side in the range of 0.1-8 bar.

54. A method according to claim 53, wherein the filtration system is dimensioned for an operating pressure on the feeding side about 3 bar.
